(19) United States
(12) Patent Application Publication
(10) Pub. No.: US 2026/0285067 A1
(43) Pub. Date: Sep. 24, 2026

(54) PRINTING ROLLER FOR A PRINTER COMPRISING A COATED TRANSPORT PORTION

(71) Applicant: Phoenix Contact GmbH & Co. KG, Blomberg (DE)

(72) Inventors: Kilian KLAGES, Detmold (DE); Albrecht SCHIERHOLZ, Schieder- Schwalenberg (DE)

(21) Appl. No.: 19/471,703

(22) PCT Filed: Apr. 2, 2024
(86) PCT No.: PCT/EP2024/058908

§ 371 Date: Oct. 2, 2025

(30) Foreign Application Priority Data
Apr. 17, 2023 (BE) BE2023/5285

(51) Int. Cl. B41J 11/057; B41J 2/325; B41J 3/407

(52) U.S. Cl. CPC B41J 11/057; B41J 2/325; B41J 3/40731

(57) ABSTRACT

The invention relates to a printing roller (1; T) for a printer (2) for printing marking profiles (3; 3′), said printing roller comprising: a shaft (10); at least one support portion (11A, 11B) mounted on the shaft (10); and a transport portion (12; 12′), that is adjacent to the at least one support portion (11A, 11B) and is connected to the shaft (10) for conjoint rotation therewith, for advancing the marking profiles (3; 3′) by rotating the shaft (10), wherein the transport portion (12; 12′) is set back radially relative to the at least one support portion (11A, 11B) with respect to an axis of rotation (D) defined by the shaft (10) so as to form a receptacle (A; A′) for the marking profile. According to the invention, the transport portion (12; 12′) is formed by a main body (120; 120′) to which a friction-enhancing coating (121; 12T) is applied.

### CROSS-REFERENCE TO PRIOR APPLICATIONS

This application is a U.S. National Phase application under 35 U.S.C. § 371 of International Application No. PCT/EP2024/058908, filed on Apr. 2, 2024, and claims benefit to Belgian Patent Application No. BE2023/5285, filed on Apr. 17, 2023. The International Application was published in German on Oct. 24, 2024 as WO 2024/217865 A1 under PCT Article 21(2).

### FIELD

The invention relates to a printing roller for a printer for printing marking profiles, to a printer comprising such a printing roller, to an arrangement comprising such a printer, and to a method for producing a printing roller.

### BACKGROUND

To print on media, printing rollers are regularly used, which transport the medium to be printed on, e.g. paper, to a print head and optionally also press it against the print head. With media to be printed on such as paper, advancing them is relatively easy to do by rubberizing the printing roller.

A printer comprising a printing roller for paper is described in US 2008/089 732 A1. The printing roller has fine particles to improve the transportation of the paper.

If media to be printed on that are spatially extended and/or rigid in comparison to paper are to be transported, the transportation thereof is generally more involved, and the printing rollers are more susceptible to wear.

WO 2018/189066 A1 describes a printer for printing marking strips, wherein the printer has a rotatably mounted feed shaft drivable by a motor and a print head. It is provided that the rotatably mounted feed shaft has at least one portion provided with sawtooth-like teeth, which rests directly on the marking strip when the feed shaft rotates, so that the feed speed of the marking strip is synchronized with the peripheral speed of the feed shaft. However, this printer is complex to manufacture and requires a high contact pressure to ensure satisfactory transport. However, if the pressure is too high, permanent, visible impressions can remain in the marking strips, which reduces the quality of the final result. Setting up a print with satisfactory results can sometimes be difficult for the user, but this may be frequently necessary, for example when changing a ribbon. As a result, unsatisfactory print results may also occur.

Further printers are described in U.S. Pat. No. 4,780,729 A and WO 2019/238 492 A1.

### SUMMARY

In an embodiment, the present invention provides a printing roller for a printer for printing marking profiles, comprising: a shaft; at least one support portion mounted on the shaft; and a transport portion adjacent to the at least one support portion and connected to the shaft for conjoint rotation therewith so as to advance the marking profiles by rotating the shaft, the transport portion being set back radially relative to the at least one support portion with respect to an axis of rotation defined by the shaft so as to form a receptacle for the marking profile, wherein the transport portion comprises a main body to which a friction-enhancing coating is applied.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a printer for printing marking profiles;

FIG. 2 is a view of a printing roller for the printer in accordance with FIG. 1;

FIG. 3 is a view of the printing roller of the printer in accordance with FIG. 1;

FIG. 4 is an enlarged view of part of the printing roller in accordance with FIG. 3;

FIG. 5 to 7 are views of parts of the printing roller in accordance with FIG. 3 comprising a marking profile;

FIG. 8 is a sectional view in accordance with the section plane A-A shown in FIG. 6;

FIG. 9 is a sectional view in accordance with the section plane B-B shown in FIG. 6;

FIGS. 10A and 10B are views of a sleeve-shaped transport portion of the printing roller in accordance with FIG. 3;

FIGS. 11A and 11B are views of a sleeve-shaped transport portion of the printing roller in accordance with FIG. 2;

FIGS. 12 and 13 are views of marking profiles; and

FIG. 14 is a view of an electrical terminal which can be marked using a marking element from one of the marking profiles in accordance with FIG. 12 or 13.

### DETAILED DESCRIPTION

In an embodiment, the present invention provides improved transportation of marking profiles for printing marking strips.

Accordingly, a printing roller for a printer for printing marking profiles comprises a shaft, at least one support portion mounted on the shaft and a transport portion that is adjacent to the at least one support portion and connected to the shaft for conjoint rotation therewith for advancing the marking profiles by rotating the shaft, wherein the transport portion is radially set back relative to the at least one support portion with respect to an axis of rotation defined by the shaft so as to form a receptacle for the marking profile, wherein the transport portion is formed by a main body to which a friction-enhancing coating is applied.

This is based on the idea that particularly the materials that enable the transport portion to be very durable, e.g. steel or aluminum, have very low friction with respect to the material from which marking strips are typically made, e.g. plastics such as PA, PC or PE. Even teeth can only achieve reliable advancement with sufficient pressure. A coating that increases friction with respect to the material of the marking profiles in comparison to the material of the main body solves this problem in a simple way so as to enable particularly reliable and easily adjustable transport because different properties are provided for the structure of the component and for the contact of the marking profiles. Such a printing roller also allows for a particularly robust and durable design. This improves the transport of marking profiles for printing on the marking profiles.

The coating optionally comprises or consists of corundum, a carbide, in particular tungsten carbide, and/or diamond. These materials are particularly durable and allow for particularly good transport results.

Optionally, the (or a) material of the coating has a Mohs hardness of 6 or more, of 7 or more, in particular of 8 or more, in particular of 9 or more. This also allows particularly good transport results to be achieved.

For example, the coating has a grain size of 0.1 mm to 0.5 or 0.7 mm, in particular from 0.1 mm to 0.25 mm. This very effectively prevents visible impressions, and at the same time, very good friction with respect to the marking profiles is achieved.

Optionally, the coating is glued to the main body, e.g. using a resin or the like. Alternatively or additionally, the coating can be incorporated into the material of the main body and, for example, thus anchored thereto. Particularly effective anchoring is possible by applying the coating galvanically. Nickel is optionally deposited in this case. Grains of the coating can be nickeled in the process. The coating can also be applied by flame spraying. Furthermore, the coating can be applied by means of chemical vapor deposition (CVD). In this case, for example, carbon atoms of the gas are deposited as diamond crystallites on the tool surface.

The at least one support portion may have a carrier and a ring surrounding the carrier. For example, the carrier is rotatably mounted on the shaft, and/or the ring is rotatably mounted on the carrier. This allows the print head to be protected from damage.

The ring optionally comprises or consists of an elastic material, in particular rubber. This enables particularly good protection for the print head even when a marking profile is not inserted into the printer and the print head is closed.

The ring optionally has a thickness of 0.5 mm to 3.0 mm. This allows for good suspension and good compensation for inaccuracies.

The at least one support portion, or at least part thereof, such as the carrier and/or ring, can be rotatably mounted on the shaft, as already mentioned. This allows the print head to be protected from damage.

For example, two support portions are provided. The transport portion can be arranged between the two support portions. This allows the marking profile to be supported laterally on both sides.

It can be provided that the main body of the transport portion is formed by a sleeve that is in engagement with the shaft for conjoint rotation therewith, which allows an replaceable arrangement to be created, e.g. with a plurality of different transport portions for differently shaped marking profiles. Alternatively, the main body is formed, for example, by part of the shaft and/or is formed integrally therewith, which allows for a particularly robust design.

Optionally, at least portions of the shaft have a form-fitting profile, in particular a D-profile. This easily allows for mounting with conjoint rotation to be created.

For example, the at least one support portion and/or the transport portion are placed on the shaft and are optionally secured axially to the shaft on both sides by means of a stopper that can be releasably fixed to the shaft. This allows an easily replaceable unit to be created.

It can be provided that the shaft has an engagement for being driven by a motor of the printer. This means the shaft can be easily removed and reinserted. In addition, this ensures reliable driving of the shaft. For example, the engagement has a form-fitting profile such as a hexagonal profile.

According to one aspect, a printing roller for a printer for printing marking profiles is specified, in particular according to any one of the preceding embodiments, comprising: a shaft, two support portions mounted on the shaft, a transport portion arranged between the two support portions and placed onto the shaft for conjoint rotation therewith for advancing the marking profiles by rotating the shaft, wherein the transport portion is formed by a main body to which an (e.g. granular) coating is applied, and two stoppers which can be releasably fixed to the shaft for axially securing the support portions and the transport portion on the shaft.

According to one aspect, a printer for printing marking profiles is specified, comprising a printing roller according to any embodiment described herein and a print head arranged or arrangeable adjacently to the printing roller. The printing roller is in particular arranged so that it can press a marking profile against the print head.

According to one aspect, an arrangement is specified, comprising a printer according to any embodiment described herein and a marking profile, wherein the receptacle of the printing roller of the printer optionally has a shape that matches an underside of the marking profile.

In the arrangement, it can be provided that the marking profile has a printing surface that can be printed by the print head on an upper side facing away from the underside.

Optionally, the marking profile has at least one latching element on the underside. The marking profile can, for example, be divided into a plurality of marking elements. For example, a marking element can be easily snapped onto an electrical terminal to mark the terminal.

According to one aspect, a method for producing a printing roller according to any embodiment described herein is specified, comprising the following steps: producing or providing the main body for the transport portion and applying a (in particular friction-enhancing) coating to the main body for producing the transport portion.

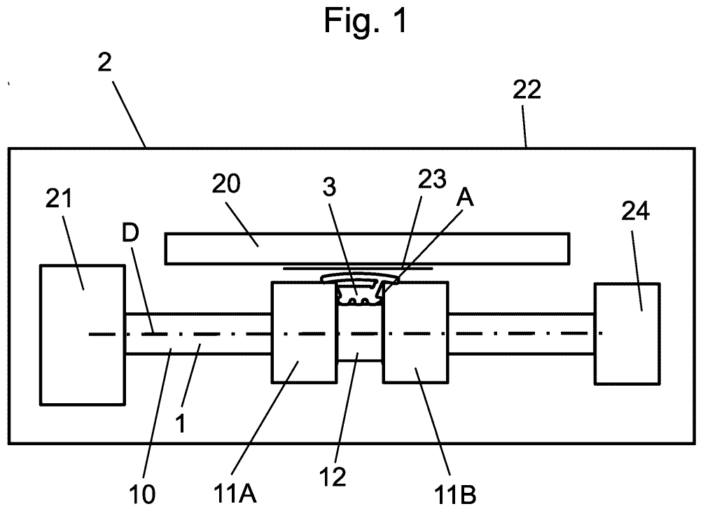

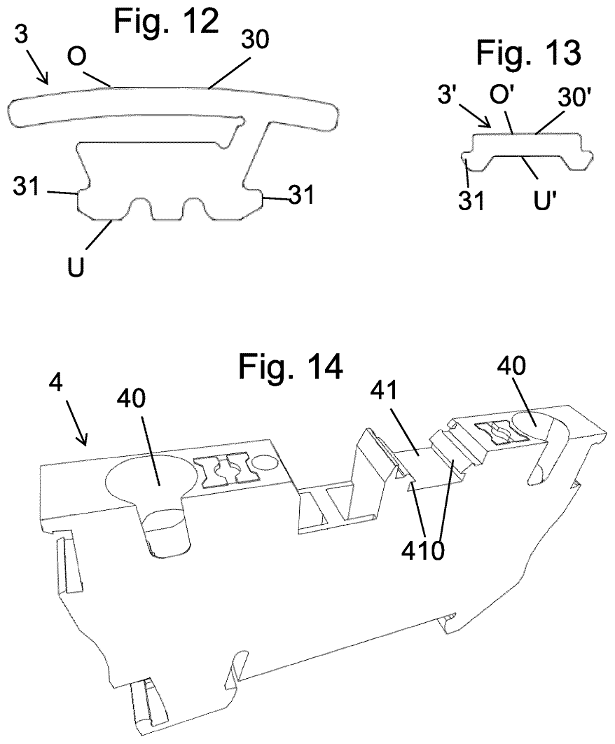

FIG. 1 shows a printer 2 for printing marking profiles 3 in an arrangement in which a marking profile 3 is inserted into the printer 2. The marking profile 3 is shown in this case on the end face and is elongated. For example, the marking profile 3 is unrolled from a roll. The marking profile 3 can be longer than 10 cm, in particular longer than 1 m. The marking profile is made of an (in particular thermoplastic) plastics, e.g. polyamide or polycarbonate. Example shapes of marking profiles will be explained below in connection with FIGS. 12 and 13.

The printer 2 further comprises a printing roller 1 which is driven by a motor 21 of the printer 2. The printing roller 1 is mounted so as to rotate about an axis of rotation D relative to a housing 22 of the printer 2. The printing roller 1 comprises a shaft 10. In the present case, one end of the shaft 10 of the printing roller 1 is mounted in a pivot bearing 24. The pivot bearing 24 is mounted in this case on the housing 22. The pivot bearing 24 is, for example, a plain bearing, wherein a ball bearing, roller bearing or the like is also conceivable. The printing roller 1 is arranged in the housing 22 so as to rotate relative to the housing 22. The other end of the shaft 10 interlockingly engages with a motor output shaft of a gearbox driven by the motor 21, which forms a motor/gearbox unit with the motor 21.

The printing roller 1 further comprises at least one support portion 11A, 11B mounted on the shaft, this being, in the example shown, two such support portions 11A, 11B, and a transport portion 12 that is adjacent to the at least one support portion 11A, 11B (namely in this case between the two support portions 11A, 11B) and connected to the shaft 10 for conjoint rotation therewith for advancing the marking profile 3 by a rotational movement of the shaft 10 about the axis of rotation D instigated by the motor 21.

The transport portion 12 is radially set back from the support portions 11A, 11B with respect to the axis of rotation D defined by the shaft 10 so that a receptacle A for the marking profile is formed. The support portions 11A, 11B have a larger diameter (perpendicularly to the axis of rotation D) than the transport portion 12. The support portions 11A, 11B have a circular cylindrical outer shape. As explained in more detail below, the transport portion 12 is formed by a main body 120 to which a friction-enhancing coating is applied. In the example shown, the transport portion 12 has a circular cylindrical shape.

A print head 20 of the printer 2 is adjacent to the printing roller 1. In the example shown, the printer 2 is designed as a thermal transfer printer. Thermal transfer printers are particularly well suited for printing marking profiles 3, e.g. for producing labels. A transfer film 23 (e.g. in the form of a carrier film with an ink layer) is transported through the marking profile 3 under the fixed print head 20 (in the housing 22) (in this case, for example, in the form of a thermal line). In this case, (small) electrical resistors in the print head 20 are heated by means of current pulses so that under the resulting heat effect in conjunction with the pressure exerted by the print head 20 on the transfer film 23, ink dots are detached from the transfer film 23 and (permanently) applied to the marking profile (e.g. on labels of the marking profile 3). A print image is thereby created. The marking profile 3 is transported by means of the printing roller 1.

The printer 2 optionally comprises a cutting device for cutting the printed marking profile 3 to form individual marking elements, e.g. labels.

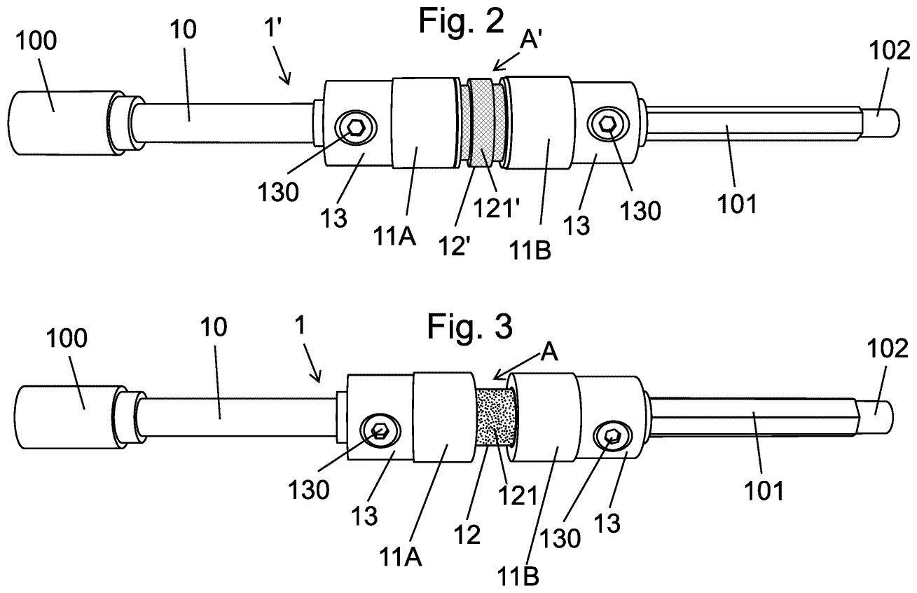

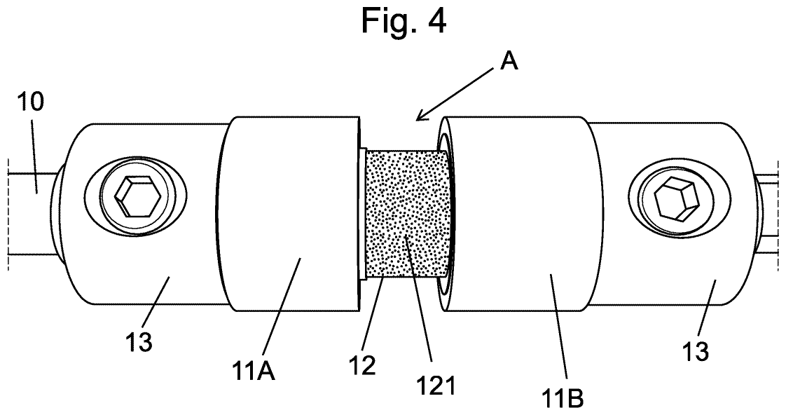

FIG. 2-4 show two printing rollers 1, 1′ with different transport portions 12, 12′. The printing roller 1 in accordance with FIGS. 3 and 4 is the printing roller 1 from FIG. 1. The printing rollers 1, 1′ of FIG. 2 and 3-4 can be identical with the exception of the transport portions 12, 12′. Optionally, this is a kit with a single shaft 10 onto which the different transport portions 12, 12′ can be placed to form the different printing rollers 1, 1′. A kit or set comprises, for example, a single shaft 10, two support portions 11A, 11B (and optionally two stoppers 13, as described below) and two or more different, interchangeable transport portions 12, 12′.

Each printing roller 1, 1′ comprises, in addition to the shaft 10, the support portions 11A, 11B and two stoppers 13. Since these components are identical for both printing rollers 1, 1′, their function and structure will now be explained with reference to the printing roller 1 of FIG. 3-4, which, however, applies analogously to the printing roller 1′ in accordance with FIG. 2.

The shaft 10 has an elongated rod which is provided with a form-fitting profile. The form-fitting profile allows correspondingly shaped components to be attached in a manner in which they are secured against rotating relative to the shaft 10 about the axis of rotation D. In the present case, the shaft 10 has a flattened portion 101 on one side along its longitudinal extent. While the shaft is otherwise circularly cylindrical, the flattened portion 101 has a flat surface. The cross-section is shaped like a D so that the form-fitting profile in this case is designed as a D-profile. It should be noted, however, that other form-fitting profiles are also conceivable, e.g. with a polygonal cross-section.

At one end, the shaft 10 has a pin 102 which can be inserted into the pivot bearing 24 in order to be rotatably mounted therein. At the opposite end, the shaft 10 has an engagement 100 which is provided, for example, with a hexagonal contour or other form-fitting contour. The engagement can be placed on a corresponding shaft driven by the motor 21. It should be noted that the motor-side end of the shaft 10 can alternatively also be designed as a pin or the like (and/or the bearing-side end as an engagement). On the motor side, the shaft can be coupled to the motor 21 (at a coupling portion, such as the engagement 100) in such a way that the motor 21 can transmit a torque to the shaft 10. The shaft 10 is rotatably mounted on the bearing side (by a coupling portion, such as the pin).

The transport portion 12, the support portions 11A, 11B and the stoppers 13 are each sleeve-shaped and can be placed on the shaft 10 and are placed thereon in the assembled state. As can be seen in particular from FIGS. 7, 9 and 10B, the transport portion 12 has an inner contour which is designed to match the form-fitting contour of the shaft 10. In the present case, the inner passage opening of the transport portion 12 is provided with an anti-rotation means 122 which, in the example shown, is formed by a flat surface in the otherwise circular inner contour. The transport portion 12 therefore has an inner D-profile. The transport portion 12 is axially (with respect to the axis of rotation D) placed on the shaft 10 and displaceable along the shaft 10, and, as a result of the interlocking engagement between the form-fitting contours when the transport portion 12 and the shaft 10 rotate relative to one another, at the same time is secured against such rotation. A rotation of the shaft 10 therefore causes a rotation of the transport portion 12.

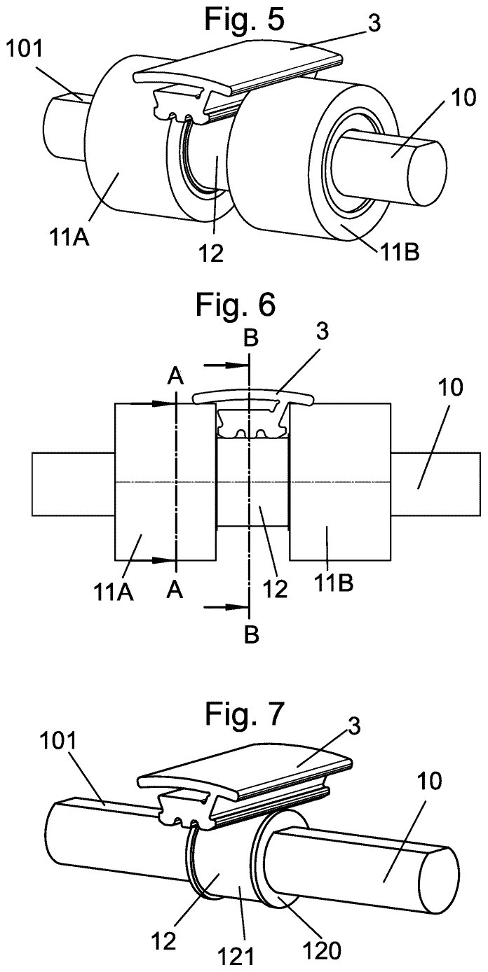

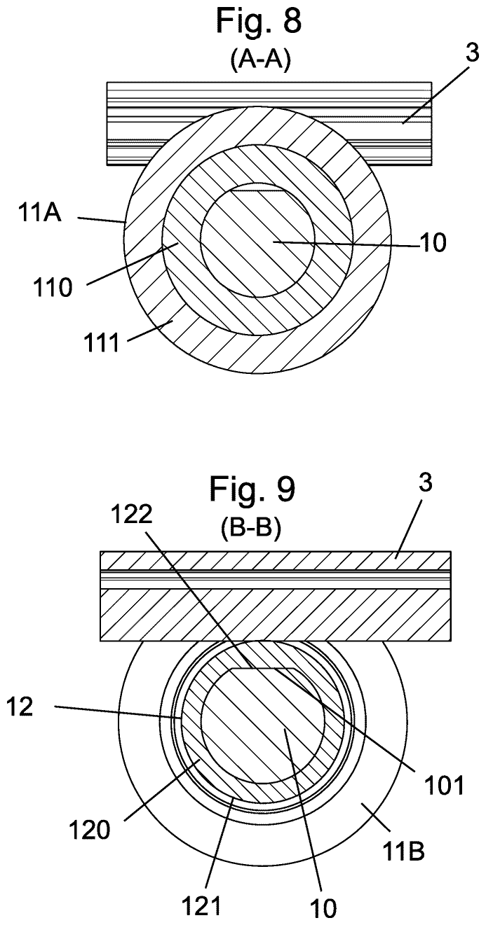

The support portions 11A, 11B have a circular inner contour, as can be seen in particular from FIGS. 5 and 8. This allows the support portions 11A, 11B to be placed on the shaft 10 and rotated relative to the shaft 10 about the axis of rotation D. The support portions 11A, 11B form a plain bearing with the shaft 10. The support portions 11A, 11B are in this case identical to one another.

When the support portions 11A, 11B come into contact with the print head 20, they can rest on the print head while the shaft 10 is rotated in the support portions 11A, 11B. This allows the print head to be protected. As illustrated in particular by FIG. 8, the support portions 11A, 11B also each have a carrier 110, which has the inner opening for the shaft 10, and a ring 111 surrounding the carrier 110. In the present example, the carrier is made of a metal material, e.g. aluminum or steel. The ring 111 in the present case is made of rubber. This allows unevenness to be compensated for and the protection of the print head 20 to be further improved. The ring 111 has a thickness in the radial direction with respect to the axis of rotation D ranging from 0.5 mm to 3.0 mm.

The print head 20 is movable relative to the shaft 10 between an open position and a closed position. In the open position, a marking profile 3 can be inserted and, for example, the transfer film 23 can be changed. Furthermore, the printing roller 1 can be replaced. Even if the print head 20 is brought into the closed position when no marking profile 3 is inserted (or when a marking profile is inserted which does not protrude beyond the support portions 11A, 11B), the support portions 11A, 11B comprising the rings 111 protect the print head 20.

The stoppers 13 can also be pushed onto the shaft 10 and each have a fastening element 130 for fixing each stopper 13 to the shaft 10. In the example shown, the fastening elements 130 are each designed as screws. This allows the stoppers 13 to be easily screwed tightly onto the shaft 10. The stoppers 13 therefore allow for axial securing on the shaft 10.

In the assembled state-see in particular FIG. 4—the transport portion 12 is arranged between the two support portions 11A, 11B, and the transport portion 12 and the support portions 11A, 11B are collectively arranged between the two stoppers 13.

Therefore, the transport portion 12 and the support portions 11A, 11B are axially fixed to the shaft 10, wherein the support portions 11A, 11B are rotatable.

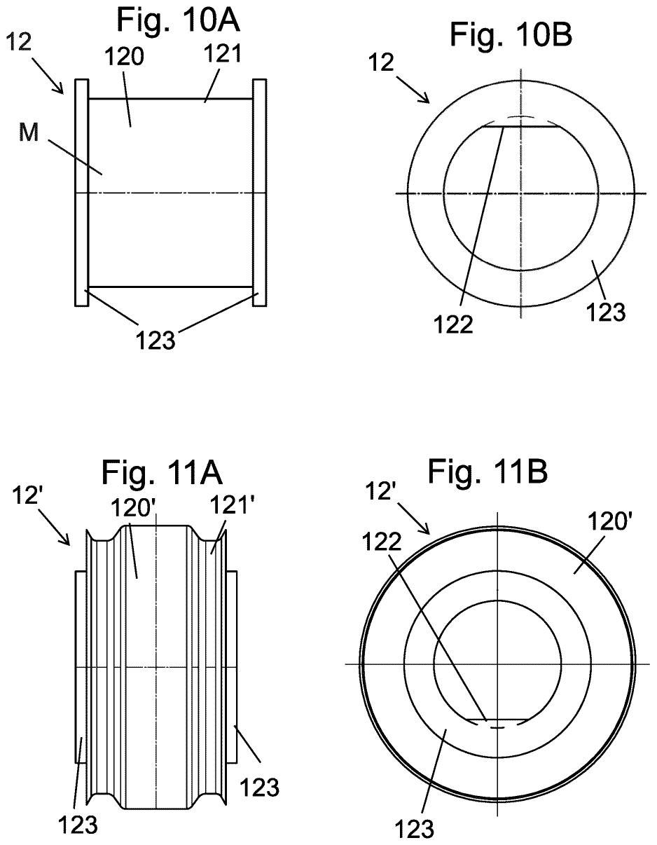

The support portions 11A, 11B have a larger diameter than the transport portion 12. This forms a receptacle A for the marking profile 3. In the example of FIG. 3-4 (see also FIGS. 5 and 6), the receptacle A is circularly cylindrical. A lateral surface M (see e.g. FIG. 10A) of the transport portion 12 is circularly cylindrical. The lateral surface M substantially extends from one support portion 11A to the other support portion 11B.

The transport portion 12 has a stop 123 on each side of the lateral surface M; see e.g. FIGS. 7, 10A and 10B. In the example shown, the stops 123 are each designed as flanges. The stops 123 ensure clamp-free contact with the support portions 11A, 11B. The stops 123 and the lateral surface M are formed by the main body 120 of the transport portion 12.

The main body 120 comprises the above-mentioned friction-enhancing coating 121 on the lateral surface M. The coating 121 consists of a material with a Mohs hardness of 7 or more, of 8 or more (optionally of 9 or more), and in this case comprises, for example, corundum, alternatively or additionally a carbide, in particular tungsten carbide, and/or diamond. The coating 121 comprises grains of this material. The grains have a grain size of 0.1 mm to 0.25 mm, in this case 0.25 mm. The grains are galvanically applied to the main body 120, alternatively glued thereto (or otherwise attached thereto or deposited thereon, e.g. by means of CVD). The coating 121 of the transport portion 12 is illustrated by dots in FIGS. 3 and 4 and is not shown in FIG. 5-10B merely for the sake of simplicity. The coating 121′ of the transport portion 12′ is illustrated in FIG. 2 by hatching and is not shown in FIG. 11A-11B either, merely for the sake of simplicity.

The coating 121 allows for particularly effective driving of the plastics marking profile 3, ensures a particularly low and, if present at all, also particularly constant slippage of the marking profile 3 during transport (printing) and has a long service life. As a result, very good printing results are enabled.

The above-described replaceability of the transport portion 12, 12′ also allows for the processing of different profile geometries using the printing roller 1 (for example, by designing the transport portion 12, 12′ in the form of an exchangeable sleeve). For alternative marking profiles 3, the transport portion 12, 12′ can also be easily replaced by the user. Furthermore, after replacing replaceable parts, no mandatory readjustment of the printing roller 1 is required. One of the stoppers 13 (in this case the motor-side stopper 13) can be left on the printing roller 1. In addition, the printing roller 1 can be adjusted laterally if necessary for optimal positioning on the material path of the printer 2.

FIG. 5-9 illustrate the transportation of the marking profile 3 by the printing roller 1 in accordance with FIG. 3-4. The marking profile 3 is also shown in FIG. 12. The marking profile 3 has a printing surface 30 as well as a foot. The printing surface 30 and the foot are connected to each other via a web (in this case an asymmetrical web, namely arranged on one side of the foot). The printing surface 30 (convex in this example) is formed on an upper side O of the marking profile 3 and the foot is formed on an underside U. The foot is inserted into the receptacle A of the printing roller 1 so that the underside U rests on the coating 121. The marking profile 3 is therefore driven on the underside U, while the upper side O faces the print head 20. The material portion forming the printing surface 30 rests with lateral end portions on the two support portions 11A, 11B; see e.g. FIGS. 1, 5 and 6. In this way, the printing surface 30 is additionally supported, while the foot rests laterally on the support portions 11A, 11B and is therefore secured against lateral slipping (parallel to the axis of rotation D).

The marking profile 3 has latching elements 31 on the foot. A printed portion of the marking profile 3 can be used to identify a device, e.g. to identify a terminal 4 as shown in FIG. 14. The terminal 4, in this case in the form of a terminal block, has, for example, a plurality of electrical connections 40 for electrical conductors in this case. A receptacle 41 for a portion of the marking profile 3 is formed on the terminal 4. Latching elements 410 are formed on the receptacle 41, with which the latching elements 31 of the marking profile 3 can engage. Accordingly, a printed portion of the marking profile 3 can be easily snapped into one or more such terminals (or other devices).

FIG. 13 shows a different shape marking profile 3′ to FIG. 12. The marking profile 3′ in accordance with FIG. 13 has a surface portion which has an upper side O′ and an underside U′ and forms a (in this example flat) printing surface 30′ on the upper side O′. On the underside U′ are latching elements 31 for engaging, for example, with the receptacle 41 of the terminal 4 or another device.

The printing roller 1′ in accordance with FIG. 2 can be used to transport the marking profile 3′. For this purpose, for example, the printing roller 1 can be removed from the printer 2 if it is arranged therein, and the printing roller 1′ in accordance with FIG. 2 is inserted. In so doing, the transport portion 12, 12′ can also be easily replaced.

The transport portion 12′ is illustrated in FIGS. 2, 11A and 11B. An outer circumferential surface of the main body 120′ of the transport portion 12′ has a shape that matches the underside U′ of the marking profile 3′. In the example shown, the outer circumferential surface has two circumferential grooves and a circular cylindrical region therebetween in the axial direction. The coating 121′ is formed both on the grooves as well as on the circular cylindrical region, wherein it would also be conceivable to form the coating 121′ only on the grooves or only on the circular cylindrical region. The annular receptacle A′ is designed to transport the marking profile 3′. The marking profile 3′ inserted therein borders the print head 20 by its printing surface 30′. As already described, the main body 120′ also has an anti-rotation means 122 at the inner opening for the shaft 10; see FIG. 11B.

A method for producing one of the described printing rollers 1; 1′ comprises producing or providing the main body 120; 120′ for the transport portion 12; 12′ and applying the coating to the main body 120; 120′ to produce the transport portion 12; 12.

The idea underlying the invention is not limited to the exemplary embodiments described above but can in principle also be realized in a completely different manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Signs

1; 1′ Printing roller
10 Shaft
100 Engagement
101 Flattened portion
102 Pin
11A, 11B Support portion
110 Carrier
111 Ring
12; 12′ Transport portion
120; 120′ Main body
121; 121′ Coating
122 Anti-rotation means
123 Stop
13 Stopper
130 Fastening element
2 Printer
20 Print head
21 Motor
22 Housing
23 Transfer film
24 Pivot bearing
3; 3′ Marking profile
30; 30′ Printing surface
31 Latching element
4 Terminal
40 Connection
41 Receptacle
410 Latching element
A; A′ Receptacle
D Axis of rotation
M Lateral surface
O; O′ Upper side
U; U′ Underside

1. A printing roller for a printer for printing marking profiles comprising:
a shaft;
at least one support portion mounted on the shaft; and
a transport portion adjacent to the at least one support portion and connected to the shaft for conjoint rotation therewith so as to advance the marking profiles by rotating the shaft, the transport portion being set back radially relative to the at least one support portion with respect to an axis of rotation defined by the shaft so as to form a receptacle for the marking profile,
wherein
the transport portion comprises a main body to which a friction-enhancing coating is applied.

2. The printing roller of claim 1, wherein the coating comprises at least one of corundum, carbide, and diamond.

3. The printing roller of claim 1, wherein a material of the coating has a Mohs hardness of at least 6.

4. The printing roller of claim 1, wherein the coating has a grain size of 0.1 mm to 0.7 mm.

5. The printing roller of claim 1, wherein the coating is glued or galvanically applied to the main body.

6. The printing roller of claim 1, wherein the at least one support portion comprises a carrier and a ring surrounding the carrier.

7. The printing roller of claim 5, wherein the ring comprises an elastic material.

8. The printing roller of claim 6, wherein the ring has a thickness of 0.5 mm to 3.0 mm.

9. The printing roller of claim 1, wherein at least part of the at least one support portion is rotatably mounted on the shaft.

10. The printing roller of claim 1, wherein the at least one support portion comprises two support portions, between which the transport portion is arranged.

11. The printing roller of claim 1, wherein the main body of the transport portion comprises a sleeve in engagement with the shaft for conjoint rotation therewith.

12. The printing roller of claim 1, wherein at least portions of the shaft have a form-fitting profile.

13. The printing roller of claim 1, wherein the at least one support portion and the transport portion are placed on the shaft and are axially secured to the shaft on both sides by a stopper configured to be releasably fixed to the shaft.

14. The printing roller of claim 1, wherein the shaft has an engagement configured to be driven by a motor of the printer.

15. The printing roller of claim 1, wherein the at least one support portion comprises
two support portions mounted on the shaft,
wherein the coating comprises
a granular coating is applied, and
wherein the printing roller further comprises two stoppers releasably fixable to the shaft for axially securing the two support portions and the transport portion to the shaft.

16. A printer for printing marking profiles comprising:
the printing roller of claim 1; and
a print head arranged or arrangeable adjacently to the printing roller.

17. An arrangement, comprising:
the printer of claim 16; and
the marking profile,
wherein the receptacle of the printing roller of the printer has a shape matching an underside of the marking profile.

18. The arrangement of claim 17, wherein the marking profile has a printing surface configured to be printable by the print head on an upper side of the marking profile facing away from the underside.

19. The arrangement of claim 17, wherein the marking profile has at least one latching element on the underside.

20. A method for producing the printing roller of claim 1, the method comprising:
producing or providing the main body for the transport portion; and
applying the coating to the main body so as to produce the transport portion.
